(19) United States
(12) Patent Application Publication
(10) Pub. No.: US 2015/0103555 A1
(43) Pub. Date: Apr. 16, 2015

(54) LIGHTING DEVICE WITH A MIXING LIGHT GUIDE BODY

(71) Applicant: VOLPI AG, Schlieren (CH)

(72) Inventor: Reinhard Jenny, Ennetbaden (CH)

(21) Appl. No.: 14/364,683

(22) PCT Filed: Dec. 12, 2012
(86) PCT No.: PCT/CH2012/000272

§ 371 Date: Dec. 12, 2014

(30) Foreign Application Priority Data
Dec. 12, 2011 (CH) 1964/11

(51) Int. Cl. F21V 8/00; F21K 99/00

(52) U.S. Cl. CPC G02B 6/0006; F21K 9/52
USPC 362/555

(57) ABSTRACT

Lighting device (1) for coupling light into a fiber optic element (3), comprising at least one light source (2) and a light guide body (4). The light guide body is designed in the form of an intersecting/penetrating body (5) with multiple light inlet surfaces (6, 6′) and with a light outlet surface (7) for the spectral and energetic homogenization of the outlet-side luminous flux (luminous intensity distribution) of the light guide body (4). Each of the light inlet surfaces (6, 6′) is paired with a light source (2, 2′). The light outlet surface (7) is optically coupled to the fiber optic element (3). The intensity distribution across the light outlet surface (7) of at least one of the radiations coupled into the inlet surfaces (6, 6′) does not have inhomogeneities.

The present invention relates to a lighting device with a light guide body for coupling light into a fiber optic element according to the preamble of claim 1, as well as to a mixing light guide body therefor.

A device for coupling LED-generated light into a light guiding fiber bundle for endoscopy is known, for example, from DE-10'2010'013'835. In this arrangement, the light of a commercially available LED, preferably a white-light LED, is guided to the coupling surface of a fiber bundle using a fiber or glass cone (light guide body). However, this type of arrangement no longer meets the growing needs for an increased and homogeneously distributed luminous density for illuminating an object, in particular in view of the increased use of electro-optical image sensors and image- and color-reproduction in digital camera technology such as is used in endoscopic medical technology, in the food industry (food safety control) or for industrial inspections.

It has therefore been suggested to use the spectral superposition of multiple LED light sources by means of a beam divider (beam splitter). Such an arrangement is known, for example, from EP-2'284'006 for a different application, and results in an almost uniform filling of the aperture accepted by the fiber bundle. Unfortunately, however, the numerical aperture of the fiber bundle and the diameter of the fiber bundle determine the dimension of the optical elements which, in order to achieve the good image quality for the task in question, should be very large. Furthermore, this arrangement requires at least three aspherical lens elements and thus undesirably takes up too much space. Also, with this arrangement, the collector aperture on the side of the LED has been shown to be much smaller than the emission aperture of the LEDs, which, for the present task—for use in image and color reproduction with electrooptical image sensors in digital camera technology such as is used in endoscopic medical technology, in the food industry (food safety control) or for industrial inspections—leads to undesirable radiation loss.

It is therefore the object of the present invention to provide a lighting device having a light guide body for coupling light into a fiber optic element (light waveguide), which allows to increase the luminous flux in the constricted space available in a simple manner by using conventional lighting sources (LEDs), to improve the spectral and energetic homogeneity of the luminous flux to be coupled into the light guide, and thereby to increase the illuminance, i.e. the image and color reproduction, of the illuminated objects.

This problem is remedied by a device having the features of claim 1 and in particular by a lighting device which comprises a light-mixing light guide body for coupling the light emitted by a plurality of lighting objects (LEDs) into a fiber optic element (light waveguide). This light guide body is designed in the form of an intersecting body having a plurality of light entry surfaces and a light exit surface so as to enable the spectral and energetic homogenization of the exitside luminous flux (luminous density distribution), wherein each of the entry surfaces is allocated to a light source and the exit surface faces the fiber optic element. In a first embodiment, this intersecting body comprises at least two mutually intersecting truncated cones and/or pyramids and is dimensioned such that the luminous flux conducted therein is spectrally and energetically homogenized, i.e. is evenly distributed. The expert in the field knows that the radiation characteristic and the wavelength spectrum of the respective light sources must be taken into consideration in order to achieve the inventive light homogenization. Preferably, the inventive light guide body which is designed in the shape of an intersecting body is integrally formed.

In a preferred embodiment, at least one of the light sources comprises an LED arrangement (array). In particular, this arrangement can have a plurality of LEDs with the same spectral distribution and/or a plurality of LEDs having differing spectral distribution values. It is understood that this arrangement can also comprise a plurality of LEDs having narrow band spectral distribution. For example, instead of a wide band halogen light with good color rendering, this embodiment would allow to efficiently and homogenously couple the light of several narrow band LEDs, for example with white light and IR-light into the fiber optics. It is understood that high-performance LEDs can also be used for the present invention.

In a further development of the present lighting device, this can comprise an additional mixing body and/or a lens system between the exit surface of the intersecting body and the fiber optic element, in particular to selectively adapt the optical and geometrical values of the luminous flux to the requirements of a specific application.

The advantages of the inventive lighting device are immediately apparent to the expert. In particular, light from several light sources can simultaneously be coupled into an optical fibers guide using a light guide body in the form of an intersecting body having a plurality of entry surfaces and only one exit surface, i.e. on the one hand light having differing wavelength spectrums can be coupled and, on the other hand, the luminous density (lm/mm²) of the luminous flux can be easily homogenized and increased. In particular, instead of broadband halogen light, narrow band white light and IR-light can be homogenously coupled into the fiber optics.

The lighting device according to the present invention is particularly suitable for use in electronic image evaluation using a fiber optical system for illuminating an object field, which is common for automated inspections, in particular for color recognition in industrial manufacture, in medical technology or in food safety control.

The invention shall be described more closely by means of a detailed embodiment and with the aid of the Figures. These show:

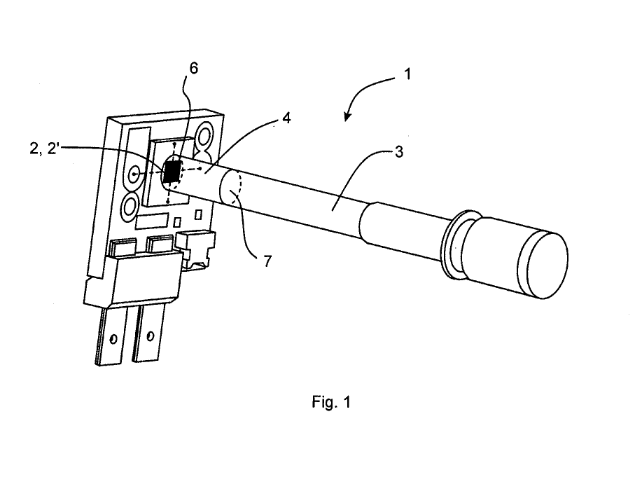

FIG. 1: a known endoscopic lighting device;

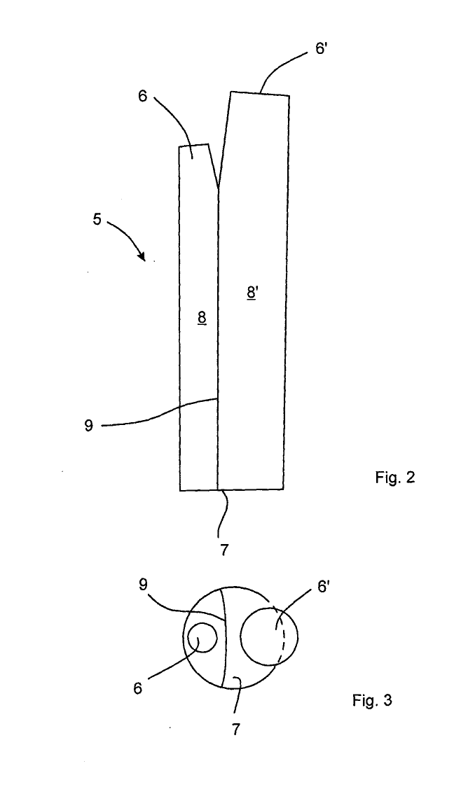

FIG. 2: a sectional view of an inventive light guide body;

FIG. 3: a top view of the light guide body in FIG. 2.

The known endoscopic lighting device (1) shown in FIG. 1 has an LED light source (2, 2′), whose emitted light is caught by a light guide body (4), in this case by a fiber or glass cone, and is then directed via a light exit surface (7) to a fiber optic element (3) by means of a light guide cable or fiber bundle. The light entry surface (6) is grinded in order to increase the coupling efficacy between the light source (2, 2′) and the entry surface (6) of the light guide body (4).

The total coupling efficacy of this type of optics can be determined as follows:

E_{Optics}=E_{LED-Optics}×E_{Optic-Fiber}=Φ_{F}/Φ_{LED}×T_{Fiber})

whereby
E_{LED-Optics} . . . coupling efficacy of LED into the coupling optics,
E_{optic-Fiber} . . . coupling efficacy of the coupling optics into the fiber bundle,
Φ_{F} . . . luminous flux emitted from the fiber bundle,
Φ_{LED} . . . luminous flux emitted by the LED at max. power,
T_{Fiber} . . . transmission of the fiber bundle.
   Thus, the luminous flux emitted from the fiber bundle can be calculated as follows:

Φ_{F}=Φ_{LED}×E_{LED-Optics}×E_{Optic-Fiber}×T_{Fiber}

Today's high power LED light sources for the visible range spectrum (VIS-spectrum) are able to achieve a luminous flux Φ_{F} of about 1000 lumen emitted from the fiber bundle by means of a simple conical optical system; and a luminous power of about 800-900 mW can be achieved with suitable high power LEDs for the spectral range in the near-infrared spectrum between 800-1050 nm (NIR-spectrum). Thus it follows that use of an LED emitting about 4000 lumen=Φ_{LED}, and of a fiber bundle (ø=13.2 mm; L=1 m) with a fiber bundle transmission of T_{Fiber}=0.55 results in a total coupling efficacy of 1000/(4000×0.55)=0.45.

In contrast therewith, the inventive lighting device (1) uses a light guide body (4) in the form of an intersecting body (5), as is shown for example, in cross-section in FIG. 2. The intersecting body (5) shown in FIG. 2 comprises two different truncated cones (8, 8′) with a common light exit surface (7). The light entry surfaces (6, 6′) of the respective truncated cones (8, 8′) are inclined towards each other, and in particular are orthogonal to their respective symmetrical axes. The course of the junction line (9) is a result of the geometry, i.e. the cone angle and the height, of both truncated cones (8, 8′). The height of these truncated cones (8, 8′), their cone angle and the size of their respective entry surfaces (6, 6′) as well as their common exit surface (7) will be dimensioned and adapted to the respective light sources by the expert in such a manner so as to provide an optimum light mixture (homogenization).

According to the present invention, and in order to superimpose and mix two spectral ranges, two conical optical systems are chosen whose dimensions are configured as a single element. According to the invention, the conical optical systems are unified towards the coupling-out side in order to achieve a mixture of the rays of both spectral ranges. In the following, this type of arrangement shall also be called an entangled conical optical system or conical optical module. Because the LEDs used have differing dimensions, the geometry of each conical optical system will be adjusted accordingly. As a rule, the smaller the tilting angle 2α of the conical axes is, the better the coupling-in efficiency becomes, because the aperture of the emitted radiation changes with the tilting angle of the conical axes, which can ultimately effect the coupling-in efficiency.

FIG. 3 is a top view of an intersecting body (5) as shown in FIG. 2. This FIG. 3 shows that the entry surfaces (6, 6′) can have varying cross-sectional surfaces. The course of the junction line (9) depends largely upon the geometry of the individual light guide bodies (8, 8′), whereas the cross section of the common exit surface is adapted to the entry surface of the fiber optic element (3). It is understood that these surfaces can be circular or rectangular, depending upon the field of application.

In a first embodiment, and taking the above into consideration, the two truncated cones (8, 8′) are inclined at an angle of 10° toward each other, the cross sections of the entry surfaces (6, 6′) are each 4 mm or 8 mm, the two truncated cones (8, 8′) have a length of 49 mm or 56 mm, and comprise a common exit surface (7) having a diameter of 14 mm.

As a result of the inclination of the optical partial cones, the center of the radiation emitted by the entangled conical optics is not at 0° but is displaced by a few degrees. However, in the preferred embodiment of the present invention, this has a negligible effect on the couple-in efficiency, because the angle distribution of the emitted radiation essentially still lies in the region of the aperture of the fiber optic component and can further be mixed there. The distribution of intensity across the coupling-out area of the inventive intersecting body does not, for example, show any noticeable inhomogeneities for the radiation in the VIS-spectrum, and for the NIR-spectrum merely shows a directionally influenced emission which, in turn, lies in the aperture of the fiber optic component and can further be mixed. In this way, the high couple-in efficiency of a simple conical optical system can be used to its full extent for an inventive intersecting body.

In a further embodiment of the lighting device according to the invention, the intersecting body can comprise three or four or more conical bodies; it is also possible that different, for example truncated pyramid like light guide bodies, can be designed in the form of an intersecting body. It is understood that the cross sections of the entry surfaces (6, 6′) and of the exit surface (7) can have variable shapes and sizes, in particular not necessarily circular but also elliptical or rectangular. Of course, the intersecting body can also be integrally formed, i.e. can be made of one piece of the same material.

### References:

1 lighting device

2 light source

3 fiber optical element (light guide)

4 light guide body

5 intersecting/penetrating body

6, 6′ light entry surfaces

7 light exit surface

8, 8′ truncated cone or pyramid

1. Lighting device (1) with a light guide body (4) for coupling the light of at least one light source (2) into a fiber optic element (3) of said lighting device (1), characterized in that, for the spectral and energetic homogenization of the exit-side luminous flux (luminous density distribution) of the light guide body (4), this is designed as an intersecting body (5) having a plurality of light entry surfaces (6, 6′) and a light exit surface (7), wherein each of the light entry surfaces (6, 6′) is allocated to a light source (2, 2′) and the light exit surface (7) is optically coupled with the fiber optic element (3).

2. Device according to claim 1, characterized in that at least one of the light sources (2, 2′) comprises a LED arrangement (array).

3. Device according to claim 2, characterized in that the LED arrangement comprises a plurality of LEDs having the same spectral distribution and/or a plurality of differing spectral distributions and/or a plurality of LEDs with narrowband spectral distribution.

4. Device according to claim 1, characterized in that the intersecting body (5) comprises at least two mutually intersecting truncated cones and/or pyramids.

5. Device according to claim 4, characterized in that a further mixing body is arranged between the light exit surface (7) of the intersecting body (5) and the fiber optic element (3).

6. Device according to one of claims 1 to 5, claim 1, characterized in that the intersecting body (5) is dimensioned and arranged such, that the intensity distribution across the light exit surface (7) of at least one of the radiations coupled into the entry surfaces (6, 6′) has no inhomogeneities.

7. Light guide body (4) for use in a device according to claim 1, characterized in that it has the shape of an intersecting body, with a plurality of light entry surfaces (6, 6′) and with a light exit surface (7), wherein each of the light entry surfaces (6, 6′) is allocated to a light source (2, 2′) and the light exit surface (7) can be optically coupled to a fiber optic element (3).

8. Light guide body (4) according to claim 7, characterized in that it is integrally formed.

9. Light guide body (4) according to claim 7, characterized in that the cross section of the light entry surfaces (6, 6′) and/or the light exit surface (7) is circular, elliptic or rectangular.

10. Light guide body (4) according to claim 7, characterized in that the intersecting body (5) is dimensioned and arranged in such a manner, that the intensity distribution across the light exit surface (7) of at least one of the radiations coupled into the entry surfaces (6, 6′) has no inhomogeneities.
